(19) United States
(12) Patent Application Publication
(10) Pub. No.: US 2014/0182765 A1
(43) Pub. Date: Jul. 3, 2014

(54) INSULATION SYSTEM AND METHOD OF APPLICATION THEREOF

(71) Applicant: Calvin Doyle HEYDEN, Morinville (CA)

(72) Inventor: Calvin Doyle HEYDEN, Morinville (CA)

(21) Appl. No.: 14/221,452

(22) Filed: Mar. 21, 2014

Related U.S. Application Data
(63) Continuation of application No. 14/151,308, filed on Jan. 9, 2014.
Application No. 14/151,308 is a continuation of application No. 13/566,619, filed on Aug. 3, 2012.

(51) Int. Cl. B32B 37/18

(52) U.S. Cl. CPC B32B 37/18
USPC 156/60

(57) ABSTRACT

A system of insulation and jacketing of industrial equipment comprises an insulation layer comprising one or more layers of insulation, applied to an outer surface of the equipment and a jacketing layer applied and adhered to an outer surface of the insulation layer. An outer surface of an outermost layer of insulation is conditioned to form a smooth outer surface and promote adhesion of the jacketing layer to the insulation layer. A method of insulating and jacketing industrial equipment comprises the steps of applying an insulation layer comprising one or more layers of insulation, to an outer surface of the equipment, conditioning an outer surface of an outermost layer of insulation and applying and adhering a jacketing layer to an outer surface of the insulation layer. Conditioning the insulation layer serves to smoothen the outer surface and promote adhesion of the jacketing layer to the insulation layer.

This is a continuation application filed under 35 U.S.C. §120, claiming the benefit from U.S. application Ser. No. 14/151,308, filed Jan. 9, 2014, and U.S. application Ser. No. 13/566,619, filed Aug. 3, 2012, the content of each of which is hereby incorporated by reference in its entirety.

### FIELD OF THE INVENTION

The present invention relates to a method of insulating and jacketing a pipe or vessel and to a resulting system of insulation and jacketing for a pipe or vessel.

### BACKGROUND

In almost all chemical and industrial applications, vessels and piping carrying process materials need to be insulated or otherwise protected against outside environment. Safety and environmental regulations are also stringent in their requirements that industrial fluids, petrochemicals and waste fluids be stored and transported in complete isolation from the surrounding ecosystems.

The problem of oil or other fluid leakage into surrounding soil, water tables or rivers and lakes is a significant one that results in loss of product, ecosystem damage, loss of reputation in the public eye, fines and even criminal charges.

Vessel jacketing and piping insulation have been used for years for the purposes of insulation and containment.

Such insulation typically involves either a spray or fibre-based insulation applied to a vessel or pipe, optionally with some form of cladding applied overtop. Very often however, insulation materials are necessarily rough with many air pockets and an uneven surface. Such texture is advantageous for trapping air and insulating, but does not allow for satisfactory adhesion of the cladding. Cladding is required to ensure containment against leaks and must be applied evenly and securely.

The use of spray foam insulations produces a less uneven surface than fibre-based insulation, however it is not suitable for all applications. Conversely, fibre-based insulation result in a very uneven surface and results in poor adhesion for cladding or jacketing or the like.

A need and interest therefore exists in the art to develop improved methods of insulating and jacketing vessels and pipes and for improved systems of insulation and jacketing.

### SUMMARY

A system of insulation and jacketing of industrial equipment is provided. The system comprises an insulation layer comprising one or more layers of insulation, applied to an outer surface of the equipment and a jacketing layer applied and adhered to an outer surface of the insulation layer. An outer surface of an outermost layer of insulation is conditioned to form a smooth outer surface and promote adhesion of the jacketing layer to the insulation layer.

A method of insulating and jacketing industrial equipment is also provided. The method comprises the steps of applying an insulation layer comprising one or more layers of insulation, to an outer surface of the equipment, conditioning an outer surface of an outermost layer of insulation and applying and adhering a jacketing layer to an outer surface of the insulation layer. Conditioning the insulation layer serves to smoothen the outer surface and promote adhesion of the jacketing layer to the insulation layer.

### BRIEF DESCRIPTION OF THE DRAWINGS

The present invention will now be described in greater detail, with reference to the following drawings, in which:

FIG. 1 is perspective view of one embodiment of the present system;

FIG. 2 is cross sectional view of one example of the present system;

FIG. 3 is a cross-sectional view of one example of an insulated pipe of the present system;

FIG. 4 is a cross sectional view of another example of an insulated pipe of the present system; and

FIG. 5 is schematic diagram of one embodiment of a method of the present invention.

### DESCRIPTION OF THE INVENTION

The present invention relates to a method of insulating and cladding industrial equipment, such as piping and vessels and to an insulation and cladding system for such industrial equipment. More specifically, the present invention relates to a method of cladding or jacketing over fiber-based insulation on industrial equipment such as pipes and vessels. The present method and system provide improved leak resistance and sealing of the industrial equipment body.

For the purposes of the present invention, piping can be any process piping found in industrial facilities, as well as pipelines for transporting process fluids, petroleum and other materials across great distances. Vessels can include storage vessels, reactors, heating and cooling vessels and the like.

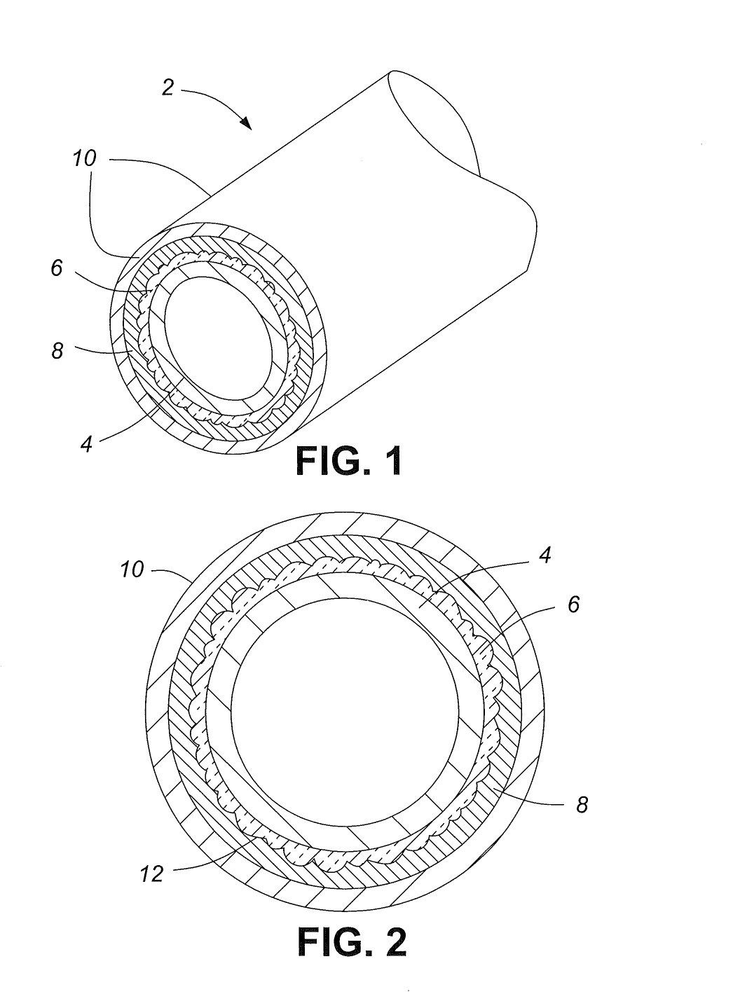

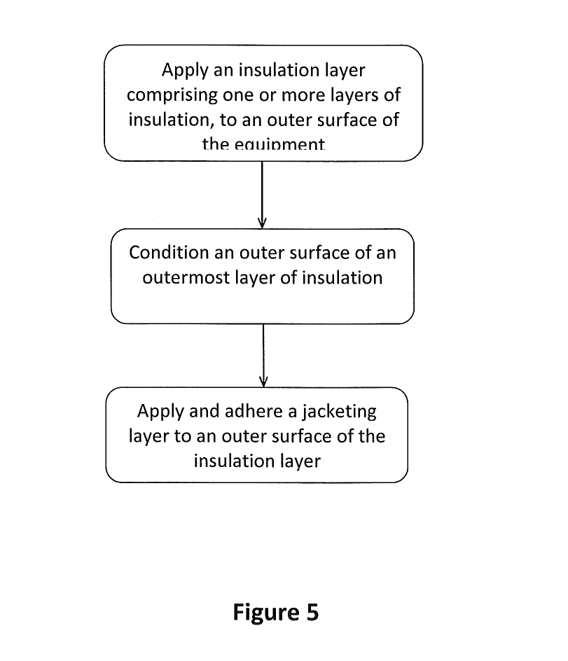

FIGS. 1 to 4 have been illustrated with a pipe as one example of the present system, however it would be understood by a skilled person in the art that any type of industrial equipment, including but not limited to pipes and vessels, can be insulated and clad using the systems and methods of the present invention. The insulated and clad system of the invention is generally indicated as 2 in FIG. 1. The method of the present invention is generally depicted in FIG. 5.

Insulation associated with the present invention can be spray foam insulations, fiber-based insulations and chemical insulations such, for example calcium silicate insulations.

More preferably the present invention relates to methods of jacketing a pipe or vessels covered with a fiber-based insulation. Such fiber-based insulations can include those made with wood fiber, glass fiber, mineral fiber and fibers composed of recycled materials.

Further preferably, the insulating material can be an aerogel. Aerogels are porous solid material made by removing the liquid component of a gel in such a way as to preserve the framework's pore structure. Aerogels can be made from a number of substances including but not limited to gels of silica, metal oxides, metals, carbon and metal chalcogenide. Most preferably, the insulating material is a silica aerogel.

It is also possible to use pyrogel based insulations, which are high-temperature insulation blankets formed of silica aerogel and reinforced with a fiber batting.

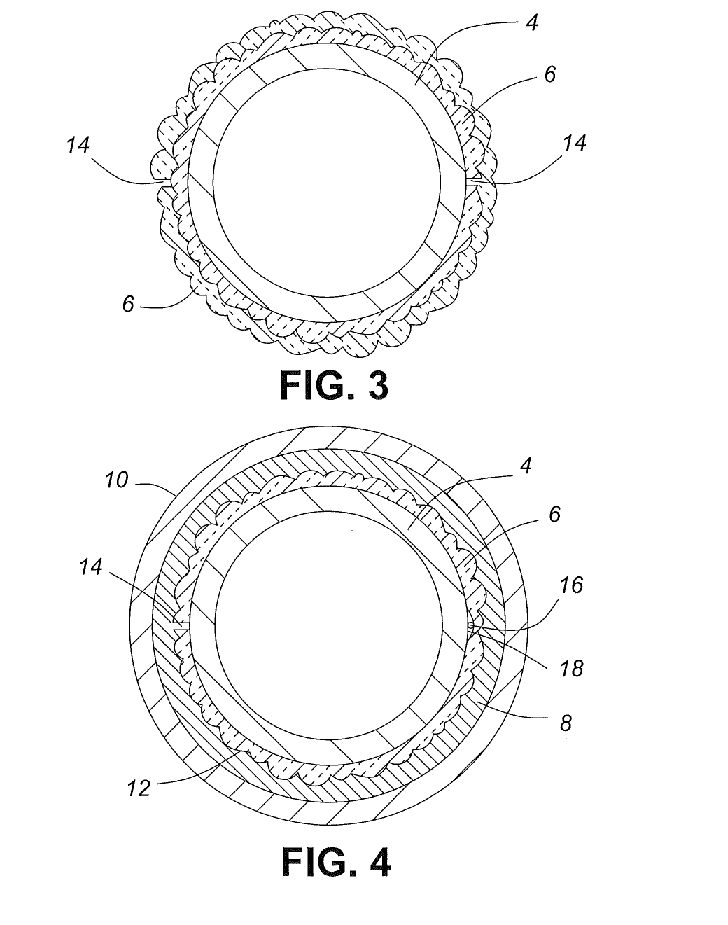

With reference to FIG. 3, in a preferred first step of the present method, a pipe or vessel 4 is covered with one or more layers of insulation 6. The layers of insulation 6 may be of the same thickness or of varying thicknesses. The layers of insulation 6 can be sealed along their longitudinal seam 14 using any well-known adhesive in the art, including but not limited to adhesives like Nashua™ adhesive tape. In the case of more than one layer of insulation 6 being applied to the pipe or vessel, sections of insulation bats or blankets are preferably applied in a brickwork pattern, such that the longitudinal seam 14 of inner layers are in misalignment with the longitudinal seams 14 of subsequent layers. Most preferably the seam 14 of inner layers is directly opposite to the seams 14 of subsequent layers of insulation.

In an alternate application depicted in FIG. 4, insulation 6 can be applied to a pipe or vessel that comprises one or more heat traced lines 16 thereupon. In such cases, the insulation 6 tends to form a void 18 next to the heat trace lines 16. It is preferred in such applications to apply the one or more layers of insulation 6 in such an orientation that the seam 14 of an innermost layer, adjacent the pipe, does not align with the heat trace line 16.

In a most preferred embodiment using aerogel insulation 6, the pipe or vessel 4 can first be coated with a protective seal (not shown) prior to application of the one or more insulation layers 6. As indicated above, any combination of insulation layer thicknesses may be applied in any order to achieve a final desired insulation thickness. For example, in the case of aerogel or of pyrogel insulation 6 applications, the insulation 6 is applied as a 15 mm layer comprising an innermost insulation layer of 5 mm thickness, covered by an outer insulation layer of 10 mm thickness. Alternatively, a total 20 mm layer of insulation 6 can be applied by applying two 10 mm thick insulation layers. Further alternatively, a total 30 mm layer of insulation 6 can be applied by applying three 10 mm layers to the pipe or vessel.

In all cases of applying more than one layer of insulation 6, the longitudinal seam 14 of an inner layer of insulation is preferably misaligned with the longitudinal seam 14 of a subsequent outer layer of insulation. Most preferably the seam 14 of a subsequent outer layer lies diametrically opposite to the longitudinal seam 14 of an inner layer of insulation, to thereby follow a ‘brickwork’ pattern of application.

Once the one or more layers of insulation 6 have been applied, an outer surface of the outermost insulating layer is treated, coated or otherwise conditioned to provide a smooth surface upon which cladding or jacketing can be applied and adhered.

In one preferred embodiment, an intermediate layer 8 is applied overtop the outermost insulation layer 6. The intermediate layer 8 provides a smooth surface and serves to even out and eliminate surface irregularities 12 typically found in the insulation layer, such as fabric nests. The intermediate layer 8 is preferably in the form of a high temperature tolerant polymer plastic film including but not limited to cross-linked or non-cross-linked polyolefin, cross-linked or non-cross-linked PVC. Such polymer films are often commercially called shrink wrap. More preferably such polymer plastic film can be applied in a thickness ranging from about 0.05 millimeters to about 0.10 millimeters and is most preferably 0.08 millimeters in thickness.

Alternatively, a layer of polymer plastic film can be applied as the intermediate layer 8 to the outermost insulation layer 6 to smoothen the insulation surface. The polymer plastic can be glued or applied and affixed by any suitable means known in the art. The polymer plastic is preferably applied as a layer having a thickness ranging from about 3 millimeters to about 10 millimeters and most preferably as a layer of 6 millimeter thickness. Such polymer plastic film is more preferably similar to those used in the construction industries as vapour barriers and the like. Polymer plastic is preferred in cases where pipes or vessels 4 are not easily accessible, for example in cases when lower surfaces of the pipes or vessels are close to the ground or other equipment.

In another embodiment, a webbing material or tape can be applied and then sprayed with a suitable polymer spray to form the intermediate layer 8. Such webbing material, can be, for example a fiberglass cross-linked tape or web sprayed with a polymer-based spray. In a most preferred example, such a webbing material is drywall tape.

In a further alternate embodiment, particularly in the case of the use of spray foam insulation as the insulation layer 6, the outermost layer of insulation 6 can be resurfaced, treated, trimmed or otherwise conditioned to smoothen its outer surface. In one preferred embodiment, the outer surface of the insulation is run through a lathe to produce a smooth outer surface and even insulation thickness along the length of pipe or vessel 4.

The surface smoothening provided by the intermediate layer 8 allows for a cladding or jacketing 10 to be applied to the insulated pipe or vessel 4, to protect the insulation layer 6 and to provide containment in the case of leaks. The intermediate layer 8 advantageously provides a smooth surface for better adhesion of a jacketing or cladding layer 10, which would otherwise not adhere to the irregular surface 12 of the insulation layer 6. Such cladding or jacketing 10 can take the form of a polymer or polyelastomer such as for example polyurea or polyurethane. The jacket 10 preferably takes the form of a sprayable or brushable liquid, or a blanket or bat. In the case of brushable liquids, the jacket is most preferably a brush grade polyurea. Most preferably the jacket 10 is polyurea liquid and can be sprayed onto the intermediate layer 8 to form the jacket 10.

Alternatively, a blanket comprising polyurea with a fabric backing can also be applied over the intermediate layer 8 and sealed in place by any suitable adhesive known in the art and most preferable by a spray adhesive into a longitudinal seam 14 of the blanket. This embodiment of jacketing 10 is preferred for applications to pipes or vessels 4 that are not easily accessible for spray jacketing for example, in cases when a lower surface of the pipes or vessels are close to the ground or other equipment.

The thickness of the jacket 10 is preferably in the range of about 60 to about 250 mm, and is most preferably about 120 mm in thickness for piping and vessels.

The thickness of the jacket 10 can be verified by any known means in the art. Commonly, thickness is tested by a destructive test of cutting the jacket 10 at varying locations along the pipe or vessel 4 and use of a thickness gauge, such as for example a dry film thickness or ultrasound gauge, to measure thickness of the jacketing layer 10. A visual or other suitable inspection technique can also be used to inspect for pinholes or undercuts in the jacketing layer. Should imperfections exist or if the jacket does not meet a minimum desired thickness, further layers of jacketing material can be sprayed or otherwise applied to the existing jacketing layer.

Preferably, the insulated, wrapped and jacketed equipment is cured for between 1 to 2 hours without disturbance.

In the foregoing specification, the invention has been described with a specific embodiment thereof; however, it will be evident that various modifications and changes may be made thereto without departing from the broader spirit and scope of the invention.

1. A method of insulating and jacketing industrial equipment, said method comprising the steps of:
a) applying an insulation layer comprising one or more layers of fiber-based insulation, to an outer surface of the equipment;
b) applying an intermediate layer to an outer surface of the insulation layer; said intermediate layer selected from the group consisting of a polymer plastic film, a polymer layer and webbing material; and
c) applying and adhering a jacketing layer to an outer surface of the intermediate layer;
wherein application of the intermediate layer serves to smoothen the outer surface of the insulation layer and promote adhesion of the jacketing layer to the insulation layer.

2. The method of claim 1, wherein the fiber-based insulation is selected from the group consisting of wood fiber insulations, glass fiber insulations, mineral fiber insulations, aerogels and pyrogel based insulations.

3. The method of claim 2, wherein the aerogel insulation is selected from the group consisting of aerogels of silica, aerogels of metal oxides, aerogels of metals, aerogels of carbon and aerogels of metal chalcogenide.

4. The method of claim 3, wherein the aerogel insulation is silica aerogel insulation.

5. The method of claim 4, wherein fiber-based insulation is pyrogel.

6. The method of claim 4, wherein the insulation is applied in more than one layer.

7. The method of claim 6, wherein the more than one layer of insulation is applied in a brickwork pattern.

8. The method of claim 1, wherein the insulation layer has a thickness of from 10 millimeters to 30 millimeters.

9. The method of claim 1, wherein the polymer plastic film is selected from the group consisting of cross-linked polyolefins, non-cross-linked polyolefins, cross-linked PVC and non-cross-linked PVC.

10. The method of claim 9, wherein the polymer plastic film has a thickness of from 0.05 millimeters to 0.10 millimeters.

11. The method of claim 1, wherein the polymer layer has a thickness of from 3 millimeters to 10 millimeters.

12. The method of claim 1, wherein the webbing material is a fiberglass cross-linked tape or web sprayed with a polymer-based spray.

13. The method of claim 1, wherein the jacketing layer is selected from the group consisting of polymers and polyelastomers.

14. The method of claim 13, wherein the jacketing layer is selected from the group consisting of polyurea and polyurethane.

15. The method of claim 13, wherein the jacketing layer is selected from the group consisting of sprayable liquids, brushable liquids, blankets and bats.

16. The method of claim 15, wherein the jacketing layer is sprayable liquid polyurea.

17. The method of claim 15, wherein the jacketing layer comprises a solid blanket comprising polyurea and a fabric backing.

18. The method of claim 1, wherein the jacketing layer has a thickness of from 60 millimeters to 250 millimeters.
